(19) United States
(12) Patent Application Publication
(10) Pub. No.: US 2023/0415085 A1
(43) Pub. Date: Dec. 28, 2023

(54) FILTER ELEMENT AND FILTER SYSTEM

(71) Applicant: MANN+HUMMEL GmbH, Ludwigsburg (DE)

(72) Inventors: Thomas LOEHL, Mundelsheim (DE); Daniel SCHMID, Sachsenheim (DE)

(21) Appl. No.: 18/466,410

(22) Filed: Sep. 13, 2023

Related U.S. Application Data
(63) Continuation of application No. PCT/EP2022/055216, filed on Mar. 2, 2022.

(30) Foreign Application Priority Data
Mar. 17, 2021 (DE) 102021106524.0

(51) Int. Cl. B01D 46/60; B01D 46/00

(52) U.S. Cl. CPC B01D 46/60; B01D 2201/34; B01D 46/0002

(57) ABSTRACT

A first filter element of a filter system is arranged in a housing, with a second filter element arranged coaxially and concentrically inside the first filter element. The first filter element has a first end disk at a first outlet-side end face and a second end disk at a second oppositely positioned end face. First and second end disks each have a central opening and extend annularly about the respective end face. The second filter element has a first outlet-side end face and a second oppositely positioned end face. The second end face of the second filter element is closed fluid-tightly by a cover. The cover closes the opening in the second end disk of the first filter element fluid-tightly. Between the second end faces of the first and second filter elements, a seal interface is arranged sealing directly the first and second filter elements against each other.

### CROSS-REFERENCE TO RELATED APPLICATIONS

This application is a continuation application of international application No. PCT/EP2022/055216, having an international filing date of 2 Mar. 2022 and designating the United States, the international application claiming a priority date of 17 Mar. 2021 based on prior filed German patent application No. 10 2021 106 524.0, the entire contents of the aforesaid international application and the aforesaid German patent application being incorporated herein by reference.

### BACKGROUND OF THE INVENTION

The invention concerns a filter element and a filter system, in particular for air, in particular the intake air of an internal combustion engine, in particular of a motor vehicle. The filter element and the filter system can be used for air filtration for fuel cells, in particular as cathode air filter. Furthermore, the filter element or the filter system can be additionally configured for adsorption of harmful gases.

EP 3 003 533 A2 discloses a filter system in which a conical secondary filter element is inserted into the clean-side interior of a cylindrical primary filter element. Annular end disks are arranged at both end faces of the filter element so that both sides of the filter element are open. The primary filter element seals axially against a housing cover. The end face of the secondary filter element which is facing the housing cover is closed and supported at the housing cover.

### SUMMARY OF THE INVENTION

It is an object of the invention to provide a filter system which permits saving material and weight at the housing.

A further object of the invention is to provide a filter element for such a filter system.

The aforementioned objects are solved according to an aspect of the invention by a filter system with a housing with an inlet and an outlet for a fluid, wherein a first filter element, embodied as a hollow body, with a filter medium is arranged in the housing and a second filter element is arranged in an interior of the first filter element, wherein the first filter element and the second filter element are arranged coaxially and concentrically to each other about a longitudinal axis,

wherein the first filter element comprises a first end disk arranged at an outlet-side end face and a second end disk arranged at the oppositely positioned end face, which end disks each have a central opening and extend substantially in an annular shape about the respective end face of the filter medium,

wherein the second filter element comprises an outlet-side first end face and a second end face positioned opposite the outlet-side end face and closed fluid-tightly by a cover,

wherein the opening in the second end disk is closed fluid-tightly by the cover, and wherein, between the second end face of the first filter element and the second end face of the second filter element, a seal interface is arranged by means of which the two filter elements seal directly against each other.

The filter system comprises a housing with an inlet and an outlet for a fluid, wherein a first filter element embodied as a hollow body—in particular hollow cylindrical—with a filter medium is arranged in the housing and a second filter element is arranged in an interior of the first filter element, wherein the first filter element and the second filter element are arranged coaxially and concentrically relative to each other about a longitudinal axis, wherein the first filter element comprises a first end disk arranged at an outlet-side end face and a second end disk arranged at the oppositely positioned end face, which end disks each comprise a central opening and extend substantially in an annular shape about the respective end face of the filter medium, wherein the second filter element comprises an outlet-side first end face and a second end face positioned opposite the outlet-side end face and closed fluid-tightly by a cover, wherein the opening in the second end disk of the first filter element is fluid-tightly closed by the cover, wherein a seal interface is arranged between the second end face of the first filter element and the second end face of the second filter element. By means of the seal interface, the two filter elements seal directly against each other.

The object is solved according to a further aspect of the invention by a filter element for a filter system, comprising a filter medium folded in particular in a zigzag shape and formed to a hollow body, a first end disk arranged at an end face and a second end disk arranged at the oppositely positioned end face, wherein the two end disks each comprise a central opening and extend substantially in an annular shape about the end faces of the filter element, wherein, at the end face which is positioned as intended opposite a clean air-side outlet in the installed state, a seal surface of a seal interface or a region of a seal element of a seal interface is provided.

The object is solved according to a further aspect of the invention by a filter element for a filter system, comprised of a single-layer or multi-layer filter medium arranged on a support pipe, a socket arranged at an end face, and a cover arranged at the oppositely positioned end face, wherein the cover comprises at least one seal surface or at least one seal element, which seal surface or seal element forms as intended a seal interface with another filter element in the installed state.

Beneficial embodiments and advantages of the invention result from the additional claims, the description, and the drawing.

A filter system is proposed which comprises a housing with an inlet and an outlet for a fluid, wherein a first filter element, embodied as a hollow body, with a filter medium is arranged about a longitudinal axis in the housing and a second filter element is arranged in an interior of the first filter element. The two filter elements are coaxially and concentrically arranged about a longitudinal axis of the first filter element. The longitudinal axis of the filter element can coincide with a longitudinal axis of the filter housing. The filter elements, however, can also be eccentrically arranged in relation to a housing axis in the filter housing. The first filter element comprises a first end disk arranged at an outlet-side end face and a second end disk arranged at the oppositely positioned end face, which end disks each comprise a central opening and extend substantially in an annular shape about the respective end face of the filter medium. The second filter element comprises an outlet-side first end face and a second end face positioned opposite the outlet-side end face and fluid-tight tightly closed by a cover. The opening in the second end disk is fluid-tightly closed by the cover, wherein a seal interface is arranged between the second end face of the first filter element and the second end face of the second filter element.

The seal interface comprises at least one seal surface at one of the filter elements and at least one seal element at the other one of the filter elements. The seal element can be formed of a foamed polymer which is foamed onto one of the filter elements or can be formed of a molded-on thermoplastic material. The foamed polymer can be in particular a polyurethane. In this context, the same material can form the seal element and the end disk. Alternatively, the seal element can be a 2-component (2K) part in which a thermoplastic elastomer is molded onto a thermoplastic carrier which is present at one of the filter elements. The carrier can be formed of a polymer, in particular PP or PA. The seal element can also be an in particular extruded seal element that is joined to the carrier.

Advantageously, the seal interface exists directly between the two filter elements. Complex additional components can be avoided. The first filter element can also be referred to as main element and the second filter element as secondary element or safety element. Preferably, the filter medium of the first filter element is a filter medium folded in a zigzag shape and configured as a hollow body. The hollow body can be cylindrically or conically embodied. Various base surfaces are conceivable; preferably, the base surface is circular or oval. In case of a circular cylindrical filter element, the end disks are correspondingly of a circular annular shape. The filter medium is preferably arranged about a support pipe. The end disks are preferably formed of a foamed polymer, in particular of a polyurethane. The housing can be expediently configured coaxially about a longitudinal axis which coincides with the longitudinal axis of the filter element, wherein in particular the housing can comprise the outlet as a socket arranged coaxially to the longitudinal axis. The second filter element comprises its end face, closed by the cover, at the side of the housing which is positioned opposite to the outlet. The filter medium of the second filter element is preferably a single-layer or multi-layer wound filter medium which is preferably arranged on a support pipe. Alternatively, the filter medium of the second filter element can be a folded bellows which is formed to a hollow body. The seal interface is thus arranged at the side of the housing which is positioned opposite the outlet. The cover can be embodied as a single part together with the support pipe of the second filter element and can be comprised of a hard plastic material, in particular a polymer such as PP or PA. In particular in case that the second filter element is embodied as a folded bellows, the cover can also be formed of a soft plastic material, in particular a foamed polyurethane, and advantageously form the end face sealing action of the folds at the same time.

The filter system is, for example, an air filter system, in particular an air filter system for an internal combustion engine, preferably an air filter system for an internal combustion engine or a fuel cell of a motor vehicle.

According to a beneficial embodiment, the seal interface can comprise at least one seal surface at a support pipe of the first filter element, which support pipe is positioned opposite the clean-side outlet, (at an end of a support pipe of the first filter element, which end of the support pipe is positioned opposite the clean-side outlet), and at least one seal element at the second filter element which seals against the seal surface in axial and/or radial direction.

Preferably, the seal element can be arranged at the second filter element directly at the cover or at a spacing to the cover. Furthermore, the first filter element can be supported at its outer side by the housing.

According to a beneficial embodiment, the seal interface can comprise a seal element, in particular a seal ring, which is arranged at a circumferentially extending projection on the cover, which projection projects at an outer end face of the cover in axial direction away from the cover, wherein the seal element seals in radial direction against a support pipe of the first filter element. The seal element can be formed of a foamed polymer, which is foamed on or about the projection, or is formed of a molded-on thermoplastic material. The foamed polymer can be in particular a polyurethane. The seal component can be a 2-component (2K) part in which a thermoplastic material is molded onto the projection.

According to a beneficial embodiment, the seal interface can comprise a seal element which is arranged at a circumferentially extending edge of the cover and which seals in radial direction against a support pipe of the first filter element. The seal element can be advantageously a shaped body of a foamed polymer which is foamed onto the edge and seals with its outer surface against the support pipe of the first filter element, or can be a thermoplastic material which is molded onto the edge.

According to a beneficial embodiment, the seal interface can comprise at the end face of the second filter element, in particular at the cover, a seal element, in particular a seal ring or a seal projection, which seals in axial direction against a rim of the support pipe of the first filter element, which rim projects inwardly in radial direction. On the cover, a circumferentially extending ring can be arranged which is embedded in the seal element; this enables a stable connection of seal element and second filter element. The seal element is preferably a foamed polymer, in particular a polyurethane, or a thermoplastic material. Advantageously, the end disk of the first filter element can at least partially overlap the inwardly projecting rim. This enables an improved seal-tightness between central pipe and end disk as well as a stable support of the seal surface. The radially inwardly projecting rim of the support pipe of the first or outer filter element can comprise a groove which is engaged by the seal element, in particular the seal projection. The seal element can seal in axial direction against the groove base and/or against an axial end face of a projection delimiting the groove.

According to a beneficial embodiment, the seal interface can comprise as a seal element a region of the second end disk of the first filter element, which end disk is positioned opposite a clean-side outlet in axial direction, and at least one seal surface at the second filter element. Advantageously, the end disk can be shaped in a desired manner by means of a suitable mold during manufacture. The end disk can provide its sealing function against the second filter element in some embodiments with support by the housing or, as an alternative, without in some embodiments.

Advantageously, the second end disk of the first filter element can project inwardly in radial direction past the filter medium. Additionally, the support pipe can be inwardly slanted, for example, and/or provided with an inwardly projecting rim at its axial end in this context. In this way, the inwardly projecting end disk can be supported in this region and stabilized. For example, in case that the seal element is part of the first filter element, the support pipe can be configured for reinforcement of a soft seal element or for attachment of the seal element. In case that the second filter element comprises or carries the seal element, the support pipe can be embodied as a counter contour for producing a seal-tight connection between the two filter elements.

According to a beneficial embodiment, the region can be arranged at an inner rim of the second end disk of the first filter element, which region seals against a seal surface at a circumferential surface, outwardly facing in radial direction, of a circumferentially extending projection arranged at the cover and projecting away from the cover in axial direction. In particular, a web at the second housing part which projects in axial direction can engage a groove of the second end disk. Advantageously, the end disk can be supported by the housing so that a reliable contact of the end disk, which forms the seal element, can be ensured at the seal surface of the second filter element.

According to a beneficial embodiment, the region of the second end disk of the first filter element can seal in radial direction against a seal surface at an inner side of a circumferentially extending projection arranged at the cover, which projection projects in axial direction away from the cover, wherein the projection can engage a groove in the end disk. In particular, an inner rim of the second end disk of the first filter element can be supported in radial direction by a web at the second housing part which projects inwardly in axial direction. A stable holding of the end disk forming the seal element of the seal interface can be ensured.

According to a beneficial embodiment, the region can be arranged at an inner rim of the second end disk of the first filter element, which inner rim seals against a seal surface at a circumferential surface, outwardly positioned in radial direction, of a circumferentially extending projection arranged at the cover and projecting away from the cover in axial direction. In order to enable a large seal surface, the end disk can comprise an axial protrusion in the region which contacts or touches the seal surface of the second filter element.

According to a beneficial embodiment, the region can be arranged at an end face, facing inwardly in axial direction, of a radial protrusion of the second end disk of the first filter element, which radial protrusion extends circumferentially within the cross section of the filter medium and seals against a seal surface at an end face of the cover. In particular, the support pipe can comprise a circumferentially extending rim projecting inwardly in radial direction and which can be embedded in the radial protrusion; this provides for a stable support of the seal interface.

According to a beneficial embodiment, an end face of the second housing part can be curved inwardly. It can be ensured that only suitable filter elements can be inserted into the housing.

According to a beneficial embodiment, the end face of the second housing part can comprise an opening which extends at least partially across the end face of the second filter element. With the second filter element installed, the opening is covered by the end face cover of the filter element. The sealing action is realized by seal locations, which are at least in sections concentric, on at least two of the components of first filter element, second filter element, and second housing part. By means of the opening, it can be ensured that only suitable filter elements can be inserted into the housing. Without having to open the housing, a visual check is possible whether a suitable second filter element is inserted. Weight can be saved due to saving material at the housing.

According to a further aspect of the invention, a filter element for a filter system according to the invention is proposed, comprising a filter medium which is folded in particular in a zigzag shape and is formed to a hollow body, a first end disk arranged at an end face, and a second end disk arranged at the oppositely positioned end face, wherein the two end disks each comprise a central opening and extend substantially in an annular shape about the end faces—in case of a folded filter medium across the folds—of the filter medium, wherein a seal surface or a region of a seal element of a seal interface is arranged at the end face which is positioned as intended opposite a clean air-side outlet in the installed state. The filter element is preferably embodied cylindrically, in particular circular cylindrically, but can also be conically embodied.

Advantageously, the filter element can be a main element in the filter system. The main element can be connected fluid-tightly to a second filter element, preferably a secondary element, by the seal interface. For example, the end disk can be formed of a foamed polymer, in particular of a polyurethane. The configuration of the filter element is compact and saves additional components for sealing. The installation in the filter system can be simplified.

According to a beneficial embodiment, the filter medium can be arranged about a support pipe, wherein the support pipe comprises the seal surface. During manufacture, the support pipe can be suitably embodied for forming the seal surface as a counter contour to a seal element. Alternatively, the support pipe can be configured for attaching a seal element and/or for reinforcing a soft seal element. The support pipe can have a rim projecting radially inwardly at which the seal surface is arranged. In particular, an axially inwardly facing section of the rim forms the seal surface.

According to a beneficial embodiment, the end disk can comprise the seal element-side region of the seal interface at the end face which is positioned as intended opposite the clean air-side outlet in the installed state. The end disk can advantageously extend in an annular shape radially inwardly past the filter medium. This annularly shaped, radially inwardly positioned region can form the seal element of the seal interface. In embodiments, this region comprises a groove which interacts with the seal surface of the counter member of the seal interface.

In this embodiment, in the filter system in which the filter element is inserted, weight can be additionally saved advantageously because, in this way, the end disk of the outer filter element must not be embodied so as to be closed. Due to the opening at the bottom of the outer filter element, end disk material can be saved.

According to a further aspect of the invention, a filter element for a filter system according to the invention is proposed, comprised of a single-layer or multi-layer filter medium arranged on a support pipe, a circumferentially extending socket arranged at an end face and projecting in axial direction, and a cover arranged at the oppositely positioned end face, wherein the cover comprises at least one seal surface or at least one seal element which seal surface or seal element forms as intended a seal interface with another filter element in the installed state. The filter medium can be wound about the support pipe or can be folded in a zigzag shape and shaped to a hollow body surrounding the support pipe.

Advantageously, the filter element can be a secondary element in the filter system. The secondary element can be connected fluid-tightly to a further filter element, preferably a main element, by means of the seal interface. The filter element is preferably cylindrical, in particular circular cylindrical, but can also be conically embodied.

Alternatively or additionally, the filter element can be embodied for harmful gas adsorption and can be connected fluid-tightly to a as particle filter element by means of the seal interface. For harmful gas adsorption, the filter element comprises a corresponding suitable filter medium, in particular an active carbon-containing filter medium.

According to a beneficial embodiment, at the cover a circumferentially extending projection can be arranged which projects in axial direction away from the cover, wherein the circumferentially extending projection can carry a seal element. Advantageously, the projection can be embedded in the seal element. For example, the seal element can be formed of a foamed polymer, in particular of a polyurethane, or of a thermoplastic material. It is also possible that the projection itself is comprised of a foamed polymer and forms the seal element, in particular in case that the second filter element is embodied as a folded bellows with foamed end disk. The projection is then producible in a simple manner as one piece together with the end disk.

According to a beneficial embodiment, a seal element can be arranged at an edge of the cover or of the support pipe. Advantageously, a foamed polymer, in particular a polyurethane, or a thermoplastic material can be arranged at the edge.

According to a beneficial embodiment, a circumferentially extending projection projecting outwardly in axial direction can be arranged at the cover as a seal surface of the seal interface. The projection can be embodied in a suitable manner in order to form a seal surface or seal interface.

### BRIEF DESCRIPTION OF THE DRAWINGS

Further advantages result from the following drawing description. In the drawings, embodiments of the invention are illustrated. The drawings, the description, and the claims contain numerous features in combination. A person of skill in the art will consider the features expediently also individually and combine them to expedient further combinations.

FIG. 1 shows a filter system according to an embodiment of the invention in a section illustration.

FIG. 2 shows a detail of a filter system according to an embodiment of the invention in a section illustration with a radial sealing action between first and second filter elements.

FIG. 3 shows a detail of a filter system according to a further embodiment of the invention in a section illustration with a radial sealing action between first and second filter elements.

FIG. 4 shows a detail of the filter system in FIG. 1 in a section illustration with an axial sealing action between first and second filter elements.

FIG. 5 shows a detail of a filter system according to a further embodiment of the invention in a section illustration with a radial sealing action between a second filter element and an end disk of a first filter element.

FIG. 6 shows a detail of a filter system according to a further embodiment of the invention in a section illustration with a radial sealing action between a first and a second filter element.

FIG. 7 shows a detail of a filter system according to a further embodiment of the invention in a section illustration with a radial sealing action between a first and a second filter element.

FIG. 8 shows a detail of a filter system according to a further embodiment of the invention in a section illustration with an axial sealing action between a first and a second filter element.

FIG. 9 shows a filter system according to a further embodiment in a section illustration.

FIG. 10 shows a detail of the embodiment according to FIG. 9 in a section illustration.

### DESCRIPTION OF PREFERRED EMBODIMENTS

In the Figures, same or same-type components are identified with same reference characters. The Figures show only examples and are not to be understood as limiting.

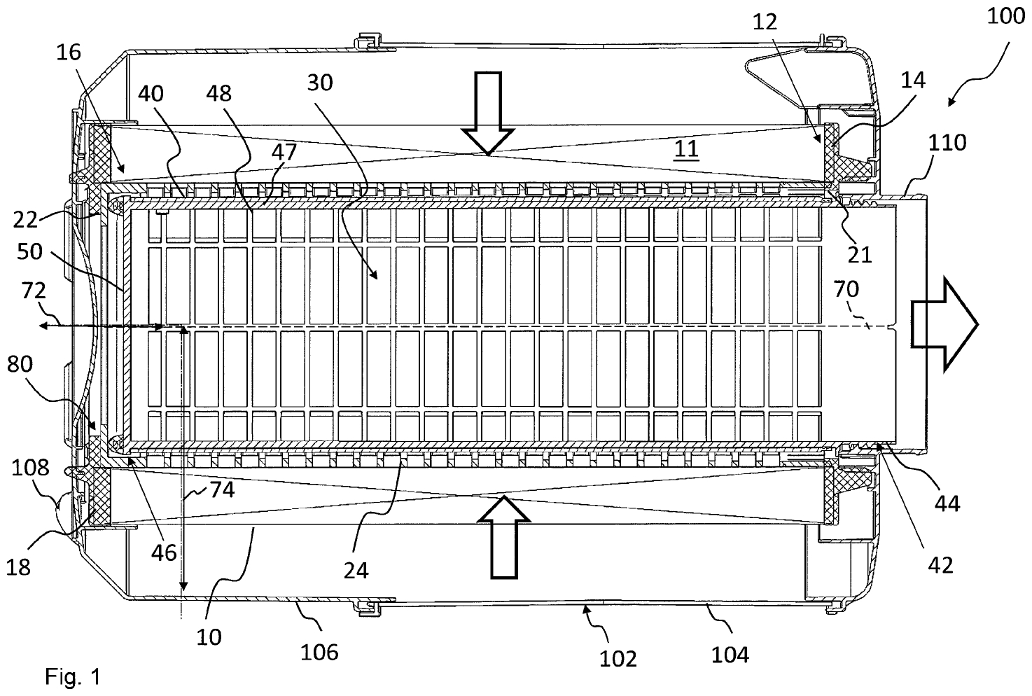

In the embodiments in FIGS. 1 to 4, a seal interface 80 comprises a seal element 60, 62, 64 at the cover 50 of the second filter element 40 and a seal surface 25 at a support pipe 24 of the first filter element 10.

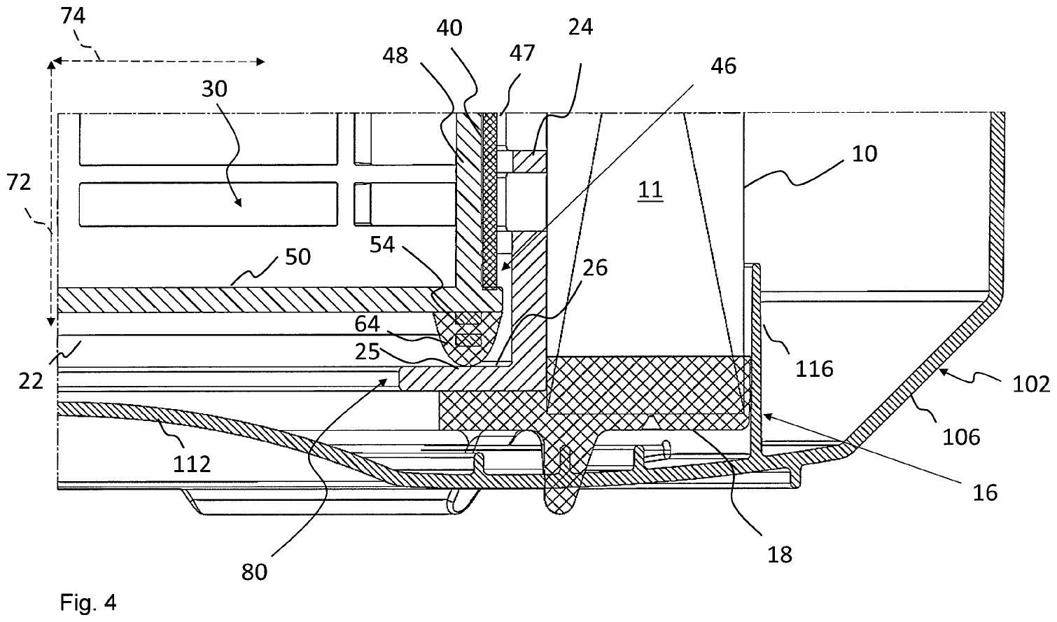

FIGS. 1 and 4 show a filter system 100 according to a first embodiment of the invention, wherein FIG. 1 is a view of a longitudinal section through the filter system 100 and FIG. 4 a detail of the filter system 100 in FIG. 1. For example, the filter system 100 is an air filter system, in particular an air filter system for an internal combustion engine, preferably an air filter system for an internal combustion engine of a motor vehicle or a cathode air filter of a fuel cell of a motor vehicle.

The filter system 100 comprises a housing 102 with an inlet 108, which can be arranged, for example, tangentially at the housing 102 and is hidden in the Figure by the housing 102, and a socket-shaped outlet 110 for a fluid which is arranged coaxially to a longitudinal axis 70. Inlet 108 and outlet 110 are arranged, for example, at oppositely positioned axial ends of the housing 102. The housing 102 comprises a first housing part 104, for example, a housing pot, and a second housing part 106, for example, a housing cover. The housing pot can be fixedly mounted and the housing cover can be pulled off from it in order to have access to the housing interior.

In the housing 102, a first filter element 10 of a hollow cylindrical configuration is arranged coaxially to the longitudinal axis 70. In an interior 30 of the first filter element 10, a second filter element 40 is arranged coaxially to the longitudinal axis 70 and concentrically to the first filter element 10.

The longitudinal axis of the housing 102 coincides in the illustrated embodiment with the longitudinal axis of the first filter element 10 and of the second filter element 40 so that here only a single common longitudinal axis 70 is referenced. However, embodiments are also conceivable in which the first filter element 10 and the second filter element 40 are arranged concentrically relative to each other about a longitudinal axis which is different from a longitudinal axis of the filter housing. In these cases, the filter elements would be eccentrically arranged in the filter housing.

The first filter element 10, also referred to as main element 10, comprises a filter medium 11 arranged on a support pipe 24. The first filter element 10 comprises a first end disk 14 arranged at an outlet-side end face 12 and a second end disk 18 arranged at the oppositely positioned end face 16. Both end disks 14, 18 each comprise an opening 21, 22 and extend substantially in an annular shape about the respective end face 12, 16 of the filter medium 11. The filter medium 11 is folded in a zigzag shape, for example. The openings 21, 22 in the illustrated embodiment are arranged coaxially to the longitudinal axis 70.

The second filter element 40, also referred to as secondary element 40, comprises a filter medium 47 arranged on a support pipe 48. For example, the filter medium 47 is applied as a single layer or many layers on the support pipe 48. The second filter element 40 comprises an outlet-side first end face 42 and a second end face 46 positioned opposite the outlet-side end face 42. The first end face 42 is open and comprises a socket 44 which is connected to the first housing part 104 at the socket-shaped outlet 110, for example, is screwed thereto by means of an outer thread, not identified in detail, at the socket 44 of the second filter element 40.

The second filter element 40 can serve as a safety element when exchanging the main filter element 10 but can be configured also as harmful gas filter element and adsorb harmful gases. For this purpose, the filter medium 47 can comprise active carbon.

The flow direction of the fluid between inlet 108 and outlet 110 through both filter elements 10, 40 is indicated by broad arrows. The filter elements 10, 40 are flowed through in radial direction 74 from the exterior to the interior. The first filter element 10 can be pulled out of the housing 102 while the second filter element 40 remains still connected to the second housing part 104 and protects the clean-side outlet 110 from unfiltered fluid.

The second filter element 40 is fluid-tightly closed by a cover 50 at its second end face 46 which is positioned opposite the clean-side outlet 110. The second filter element 40 closes the opening 22 in the second end disk 18 fluid-tightly by means of the cover 50. For fluid-tight closure of the opening 22, a seal interface 80 is arranged between the second end face 16 of the first filter element 10 and the second end face 46 of the second filter element 40. The cover 50 and the support pipe 48 of the second filter element 40 are preferably embodied together as a single piece.

At the end face regions of the filter elements 10, 40 positioned opposite the clean-side outlet 110, the seal interface 80 comprises generally at least one seal surface at one of the filter elements 10, 40 and at least one seal element at the other one of the filter elements 10, 40. The second filter element 40 closes the opening 22 in the end disk 18 of the first filter element 10 fluid-tightly without requiring additional components. Depending on the embodiment, the seal element can seal in axial direction 72 or in radial direction 74.

In the embodiment illustrated in FIG. 1, which is shown enlarged in FIG. 4, the seal interface 80 is provided with an annular seal element 64 at the cover 50 as well as a seal surface 25 at the support pipe 24 of the first filter element 10. The cover 50 and the support pipe 48 of the second filter element 40 are preferably embodied together as one piece. The seal element 64 is arranged at the end face 46 of the second filter element 40 at a circumferentially extending projection 54 of the cover 50 which is projecting outwardly in axial direction 72. The projection 54 is embedded in the seal element 64. The seal element 64 forms a circumferentially extending ring on the cover 50 and seals at the seal surface 25 axially against a rim 26 of the support pipe 24 projecting inwardly in radial direction 74. The rim 26 of the support pipe 24 is resting on the end disk 18.

In the second housing part 106, a receptacle for the first filter element 10 is provided so that the first filter element 10, in the region of its second end disk 18, contacts with its outer side a ring 116 surrounding the filter element 10. The first filter element 10 is supported by support knobs, not identified in detail, at the bottom of the second housing part 106.

In the illustrated embodiment, the second housing part 106 is inwardly curved with a depression in the end face 112 in the region of the opening 22 of the end disk 18. The depression projects into the opening 22.

Since the basic configuration of the filter elements 10, 40 and of the housing 102 is substantially identical in the various embodiments, only significant differences at the seal interface 80 will be explained in the further embodiments in order to avoid unnecessary repetitions.

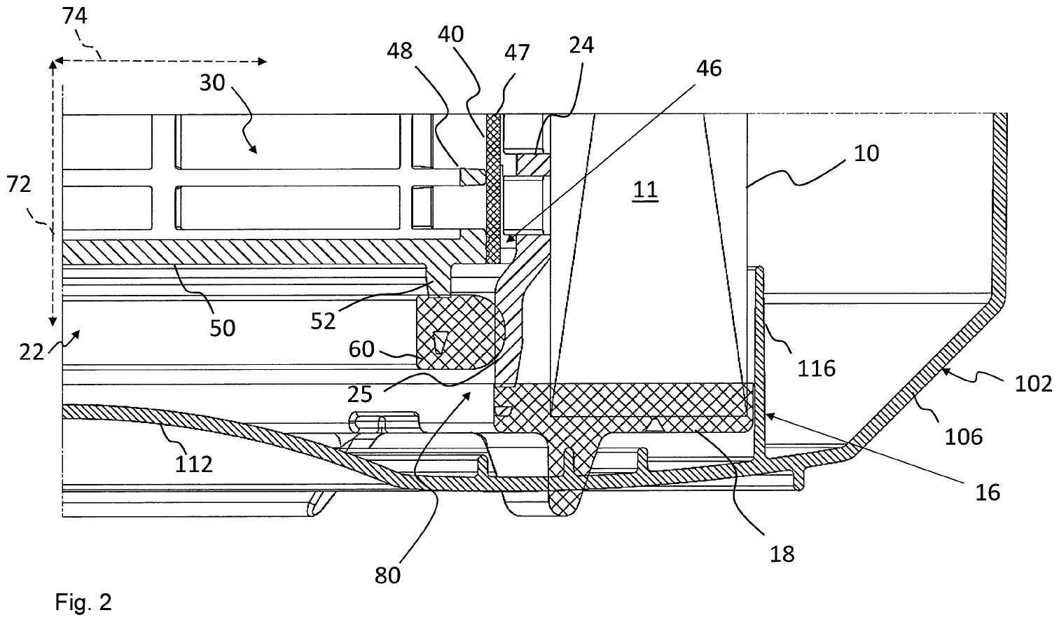

FIG. 2 shows a detail of a filter system 100 according to a further embodiment of the invention in a section illustration with a seal interface 80 with a radial sealing action between first and second filter element 10, 40.

The seal interface 80 comprises a seal element 60 embodied as a seal ring and arranged at a circumferentially extending projection 52 which projects at an outer end face of the cover 50 outwardly in axial direction 72 away from the cover 50 and is embedded in the seal element 60. The seal element 60 seals in radial direction 74 against the seal surface 25 at the support pipe 24 of the first filter element 10. The support pipe 24 comprises a cross-sectional constriction in the region of the seal surface 25 of the first filter element 10.

The first filter element 10 is received in a receptacle in the second housing part 106 and is surrounded radially outwardly by a ring 116. As before, the bottom of the second housing part 106 comprises a depression in the end face 112 in the region of the opening 22 of the end disk 18 of the first filter element 10.

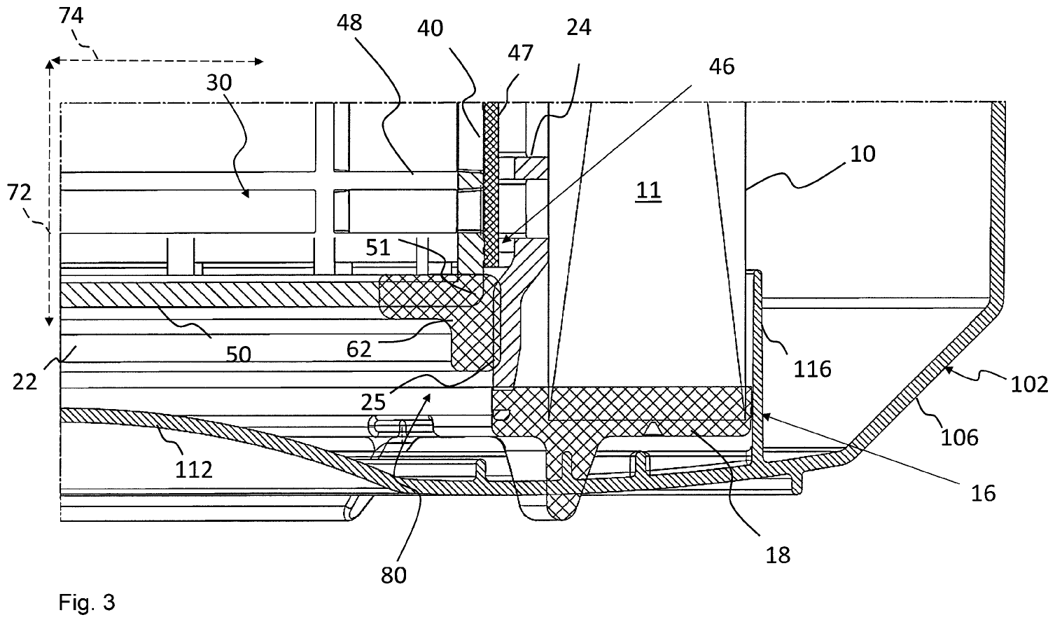

FIG. 3 shows a detail of a filter system 100 according to a further embodiment of the invention in a section illustration with a seal interface 80 with a radial sealing action between first and second filter elements 10, 40.

The seal interface 80 comprises a seal element 62 arranged at an edge 51 of the cover 50 and sealing in radial direction 74 against a support pipe 24 of the first filter element 10. The seal element 62 comprises an L-shaped cross section with a leg projecting in axial direction 72 and a leg projecting inwardly in radial direction 74. The seal element 62 can be molded on or the edge 51 can be framed with a foamed polymer.

The support pipe 24 comprises a cross-sectional constriction in the region of the seal surface 25 of the first filter element 10.

The first filter element 10 is received in a receptacle in the second housing part 106 and is surrounded radially outwardly by a ring 116. As before, the bottom of the second housing part 106 comprises a depression in the end face 112 in the region of the opening 22 of the end disk 18 of the first filter element 10.

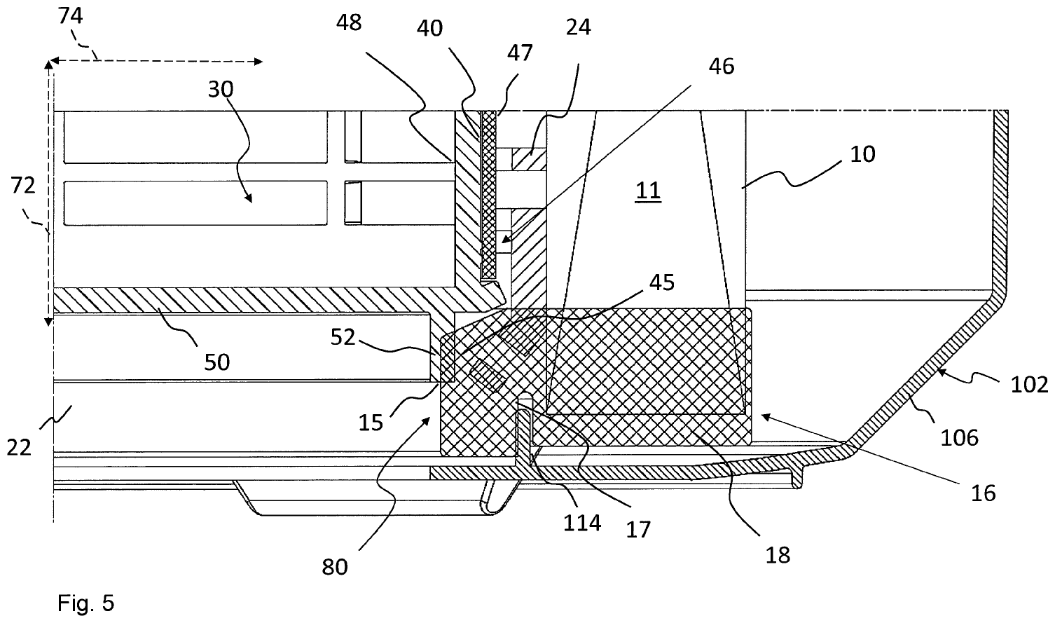

In the embodiments in FIGS. 5 to 8, the seal interface 80 comprises a region 15 of the second end disk 18 of the first filter element 10 as seal element and a seal surface 45 at the second filter element 40.

FIG. 5 shows a detail of a filter system 100 according to a further embodiment of the invention in a section illustration with a radial sealing action between first and second filter elements 10, 40.

The region 15 is arranged at an inner rim of the second end disk 18 of the first filter element 10 and seals against a seal surface 45 at a circumferential surface, outwardly positioned in radial direction 74, of a circumferentially extending projection 52 arranged at the cover 50 and projecting in axial direction 72 away from the cover 50. A web 114 at the second housing part 106 projecting in axial direction 72 engages a groove 17 of the second end disk 18. In this way, the end disk 18 is supported by the second housing part 106 of the housing 102. In this way, an outer ring 116 (FIGS. 2, 3, 4) arranged radially in relation to the first filter element 10 for receiving the first filter element 10 in the second housing part 106 can be dispensed with.

In this embodiment, the second housing part 106 in the region of the opening 22 in the second end disk 18 of the first filter element 10 is not curved but is designed open so that the cover 50 can be seen from the exterior.

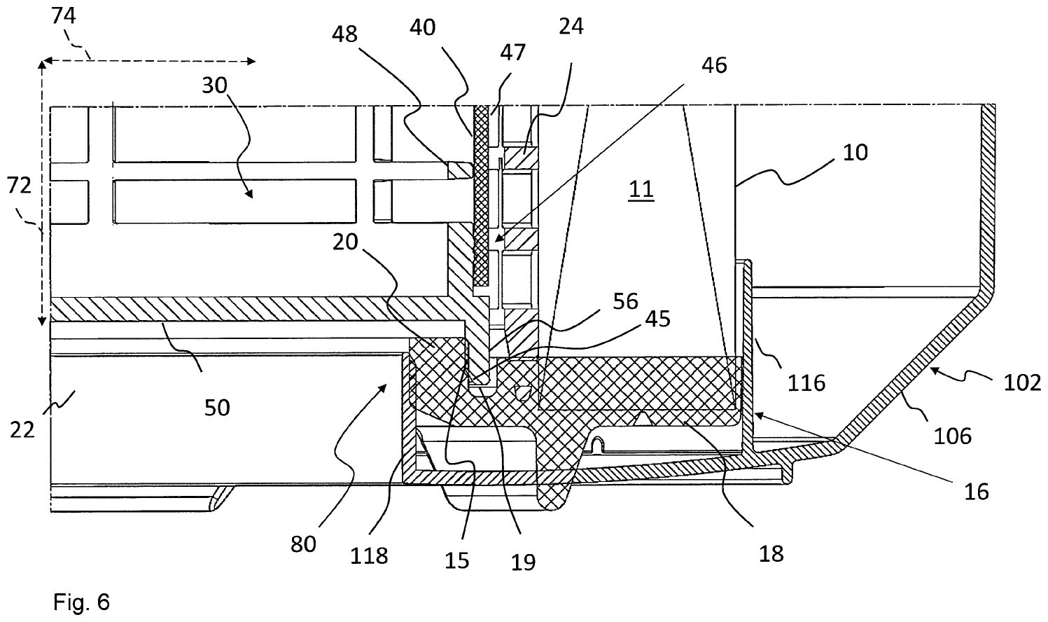

FIG. 6 shows a detail of the filter system 100 according to a further embodiment of the invention in a section illustration with a radial sealing action between first and second filter elements 10, 40.

The region 15 of the second end disk 18 of the first filter element 10 seals in radial direction 74 against a seal surface 45 at an inner side of a circumferentially extending projection 56 arranged at the cover 50. The projection 56 projects in axial direction 72 away from the cover 50 and is arranged at the outer rim of the cover 50. The end disk 18 extends with a radial protrusion 20 past the rim region of the cover 50. The projection 56 engages a groove 19 in the radial protrusion 20 of the end disk 18. The inner circumference of the second end disk 18 of the first filter element 10 is supported in radial direction 74 by a web 118 at the second housing part 106, which web is projecting inwardly in axial direction 72, and is secured in radial direction 74 between the web 118 and the ring 116 in the second housing part 106.

In this embodiment, the second housing part 106 is also not curved in the region of the opening 22 in the second end disk 18 of the first in filter element 10 but is of an open configuration so that the cover 50 can be seen from the exterior.

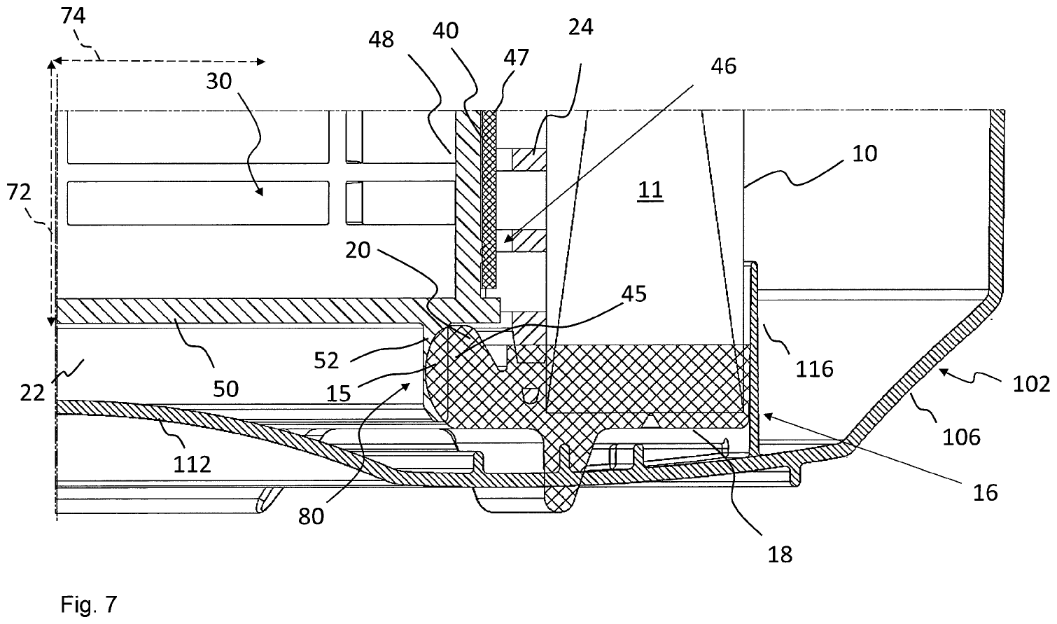

FIG. 7 shows a detail of a filter system 100 according to a further embodiment of the invention in a section illustration with a radial sealing action between first and second filter elements 10, 40. The seal interface 80 comprises a region 15 at the second end disk 18 of the first filter element 10, positioned opposite a clean-side outlet 110 (FIG. 1), and comprises at least one seal surface 45 at the second filter element 40, against which the region 15 of the second end disk 18 of the first filter element 10 is resting seal-tightly.

The second end disk 18 of the first filter element 10 projects with a radial protrusion 20 in radial direction 74 inwardly past the filter medium 11.

The region 15 is arranged at an inner rim of the second end disk 18 of the first filter element 10 which seals against a seal surface 45 at a circumferential surface, outwardly positioned in radial direction 74, of a circumferentially extending projection 52 arranged at the cover 50, which projection projects in axial direction 72 outwardly away from the cover 50.

In this embodiment, the bottom of the second housing part 106 is curved wherein a depression in the end face 112 projects into the opening 22. The filter element 10 is received in a receptacle at the second housing part 106 and is surrounded by a supporting ring 116 in the region of its second end disk 18.

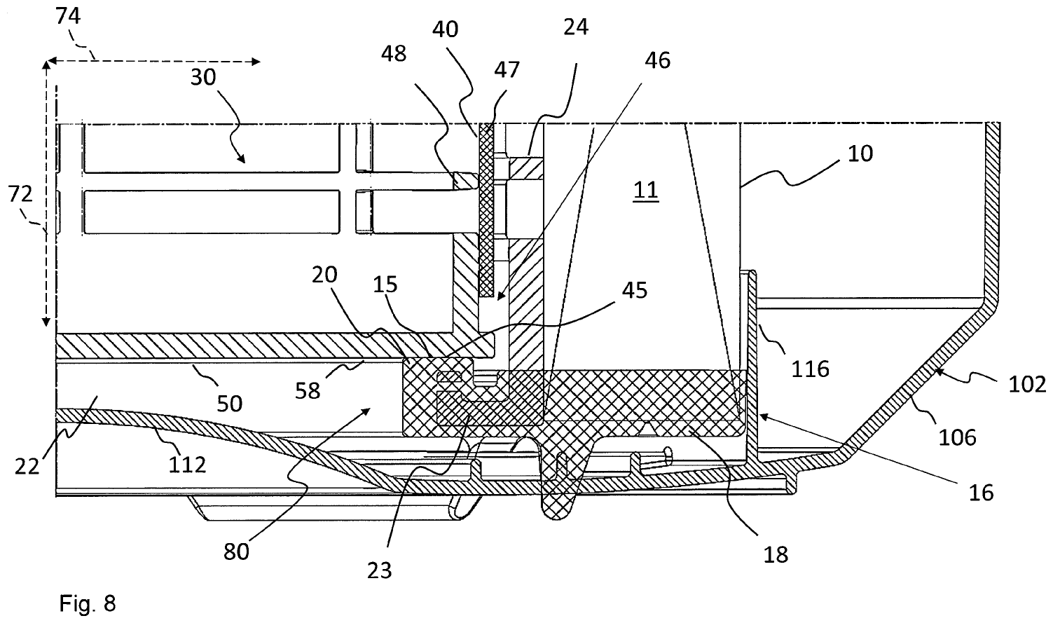

FIG. 8 shows a detail of a filter system 100 according to a further embodiment of the invention in a section illustration with an axial sealing action between first and second filter elements 10, 40.

The region 15 is arranged at an end face 58, facing inwardly in axial direction 72, of a radial protrusion 20, circumferentially extending within the cross section of the filter medium 11, of the second end disk 18 of the first filter element 10, which protrusion seals against a seal surface 45 at an end face of the cover 50. The support pipe 24 comprises a rim 23 which projects in radial direction 74 inwardly and which is embedded in the radial protrusion 20 of the second end disk 18 and thereby reinforces it. The second end disk 18 can axially support the seal interface 80 in this region.

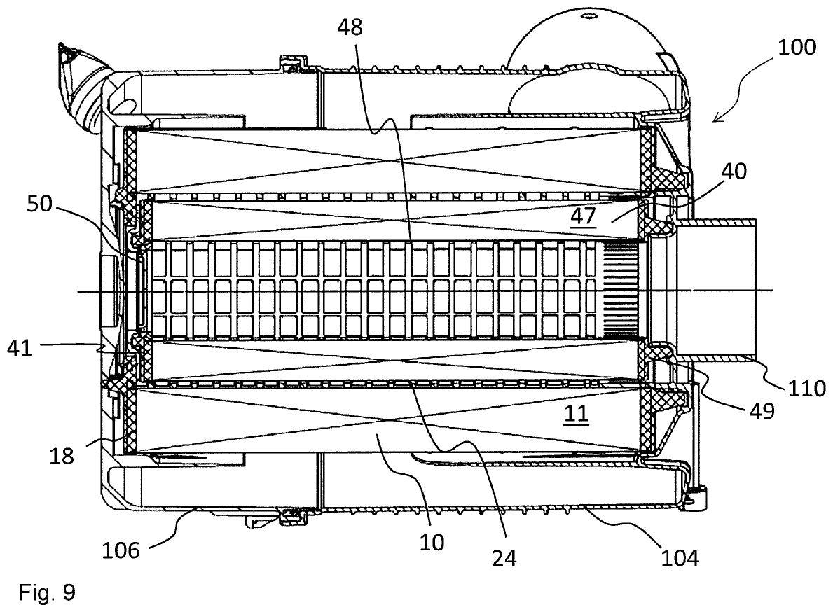

In FIG. 9, a further embodiment of a filter system 100 is illustrated, wherein the inner filter element 40 comprises a filter medium 47 in the form of a folded bellows which is arranged about a support pipe 48. At the end faces, the open folds are fluid-tightly closed by means of an end disk 41, 49, respectively. The end disks 41, 49 are formed preferably of an elastic material, in particular PUR foam. The upper end disk 49 is an open annular end disk and comprises a circumferentially extending seal bead which seals against the socket 110. The bottom end disk 41 is also of an annular configuration and surrounds the cover 50 of the support pipe 48. The support pipe 48 or the cover 50 is embedded in sections in the material of the end disk 41. As an alternative, the end disk 41 can be of a disk-shaped configuration and cover the cavity which is enclosed by the filter element 40 at the end face so that the cover 50 as part of the support pipe 48 can be dispensed with.

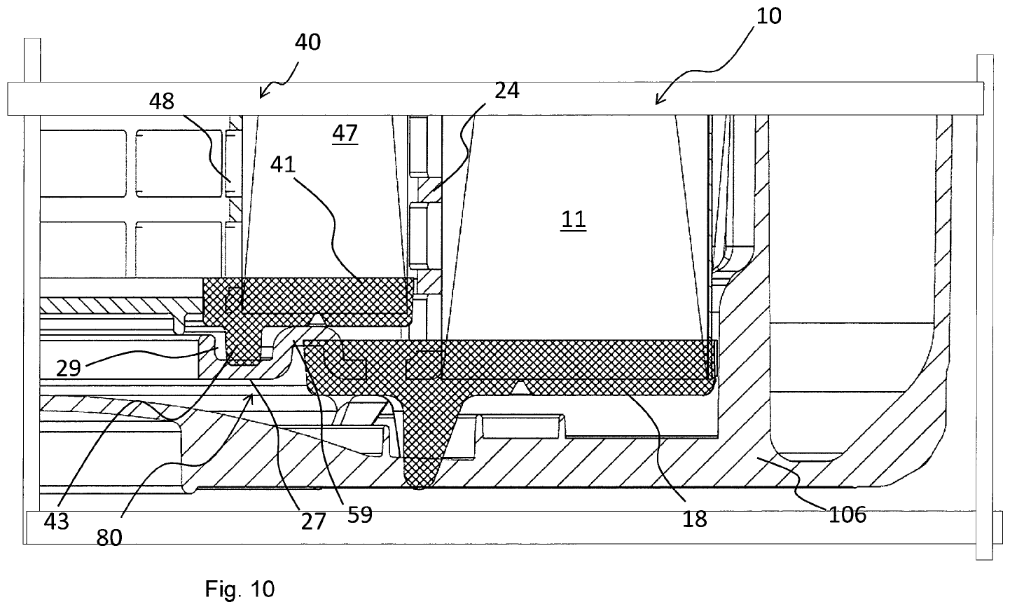

In FIG. 10, a detail of the filter system illustrated in FIG. 9 is illustrated in the region of the seal interface 80 of the bottom-side end disks 18, 41. The two filter elements 10, 40 are sealed axially relative to each other. The support pipe 24 comprises an annular rim 27 which projects inwardly in radial direction 74 and which is embedded in sections in the material of the end disk 18. Radially inwardly, the annular rim 27 comprises a groove 29 which in the radially outward direction is delimited by an annular projection 59. This groove 29 serves for receiving an axially oriented annular seal projection 43 at the bottom end disk 41 of the inner filter element 40. The annular projection 59 of the rim 27 rests axially against the flat axial end face of the end disk 41 of the inner filter element 40. Due to this configuration, a reliable axial sealing action between the two filter elements 10, 40 is ensured. The bottom end disk 41 of the inner filter element 40 forms at the same time the sealing action of the folds and the interface to the outwardly positioned filter element 10; additional sealing elements are not required.

Advantageously, the inner filter element 40 can be a filter element for harmful gas adsorption. For this purpose, the filter element is correspondingly embodied suitably for adsorption of harmful gases. Preferably, the filter medium contains active carbon.

Of course, also further seal configurations for sealing two filter elements 10, 40 embodied as folded bellows are possible. For example, a radially outer section of the bottom end disk 41 of the inner filter element 40 can seal against a rim of the support pipe 24 of the outer filter element 10, which rim projects in axial direction, for embodying a radial sealing action, similar to the embodiment of FIG. 2 or FIG. 3.

What is claimed is:

1. A filter system comprising:
a housing comprising an inlet and an outlet for a fluid;
a first filter element, comprising a filter medium and embodied as a hollow body, arranged in the housing;
a second filter element arranged in an interior of the first filter element, wherein the first filter element and the second filter element are arranged coaxially and concentrically to each other about a longitudinal axis;
the first filter element comprising a first end disk arranged at a first end face of the filter medium arranged at the outlet and further comprising a second end disk arranged at a second end face of the filter medium positioned opposite the first end face, wherein the first end disk comprise a first central opening and extends in an annular shape about the first end face, wherein the second end disk comprise a second central opening and extends in an annular shape about the second end face;
wherein the second filter element comprises a first end face arranged at the outlet and a second end face positioned opposite the first end face of the second filter element, wherein the second end face of the second filter element is closed fluid-tightly by a cover;
wherein the second opening in the second end disk of the first filter element is closed fluid-tightly by the cover;
wherein, between the second end face of the first filter element and the second end face of the second filter element, a seal interface is arranged, wherein the seal interface seals directly the first filter element and the second filter element against each other.

2. The filter system according to claim 1, wherein the first filter element comprises a support pipe, wherein the seal interface comprises a seal surface arranged at the support pipe at an end of the support pipe positioned opposite the outlet, wherein the seal interface further comprises at least one seal element arranged at the second filter element, wherein the at least one seal element seals against the seal surface in an axial direction and/or a radial direction in relation to the longitudinal axis.

3. The filter system according to claim 1, further comprising a circumferentially extending projection arranged at the cover and projecting away from an outer end face of the cover in an axial direction in relation to the longitudinal axis away from the cover, wherein the first filter element comprises a support pipe, wherein the seal interface comprises a seal element arranged at the circumferentially extending projection, wherein the seal element seals against the support pipe of the first filter element in a radial direction in relation to the longitudinal axis.

4. The filter system according to claim 1, wherein the first filter element comprises a support pipe, wherein the seal interface comprises a seal element arranged at a circumferentially extending edge of the cover, wherein the seal element seals against the support pipe of the first filter element in a radial direction in relation to the longitudinal axis.

5. The filter system according to claim 1, wherein the first filter element comprises a support pipe comprising a rim projecting inwardly in a radial direction in relation to the longitudinal axis, wherein the seal interface comprises a seal element arranged at the second end face of the second filter element, wherein the seal element seals in an axial direction in relation to the longitudinal axis against the rim of the support pipe of the first filter element.

6. The filter system according to claim 5, wherein the seal element is arranged at the cover and is a seal ring or a seal projection.

7. The filter system according to claim 1, wherein the seal interface comprises a region of the second end disk of the first filter element and further comprises at least one seal surface arranged at the second filter element.

8. The filter system according to claim 7, wherein the second end disk of the first filter element projects inwardly past the filter medium in a radial direction in relation to the longitudinal axis.

9. The filter system according to claim 7, further comprising a circumferentially extending projection arranged at the cover and projecting away from the cover in an axial direction in relation to the longitudinal axis, wherein the circumferentially extending projection comprises a circumferential surface outwardly positioned in a radial direction in relation to the longitudinal axis, wherein the region of the second end disk of the first filter element is arranged at an inner rim of the second end disk of the first filter element, wherein the inner rim seals against the at least one seal surface provided at the circumferential surface of the circumferentially extending projection.

10. The filter system according to claim 9, wherein the housing comprises a housing part comprising a web projecting inwardly in the axial direction, wherein the second end disk of the first filter element comprises a groove, and wherein the web of the housing part engages the groove of the second end disk of the first filter element.

11. The filter system according to claim 7, further comprising a circumferentially extending projection arranged at the cover and projecting away from the cover in an axial direction in relation to the longitudinal axis, wherein the circumferentially extending projection comprises the at least one seal surface, wherein the at least one seal surface is inwardly positioned in a radial direction in relation to the longitudinal axis, wherein the region of the second end disk of the first filter element seals in the radial direction against the at least one seal surface of the circumferentially extending projection, wherein the circumferentially extending projection engages a groove in the second end disk of the first filter element.

12. The filter system according to claim 7, wherein the second end disk of the first filter element comprises a radial protrusion, circumferentially extending within a cross section of the filter medium of the first filter element, wherein the region is arranged at an end face of the radial protrusion, which end face of the radial protrusion faces inwardly in an axial direction in relation to the longitudinal axis, wherein the radial protrusion seals against the at least one seal surface arranged at an end face of the cover.

13. The filter system according to claim 12, wherein the first filter element comprises a support pipe comprising a circumferentially extending rim projecting inwardly in a radial direction in relation to the longitudinal axis and embedded in the radial protrusion.

14. The filter system according to claim 1, wherein the housing comprises a housing part comprising an inwardly curved end face arranged at the second end face of the first filter element.

15. The filter system according to claim 1, wherein the housing comprises a housing part comprising an end face arranged at the second end face of the second filter element, wherein the end face of the housing part comprises an opening which extends at least partially across the second end face of the second filter element.

16. A filter element for a filter system, the filter element comprising:
a filter medium formed to a hollow body about a longitudinal axis;
a first end disk arranged at a first end face of the filter medium and a second end disk arranged at an oppositely positioned second end face of the filter medium;
the first end disk comprising a first central opening and extending in an annular shape about the first end face;
the second end disk comprising a second central opening and extending in an annular shape about the second end face;
wherein a seal surface of a seal interface or a region of a seal interface is arranged at the second end face configured to be positioned as intended opposite an outlet of the filter system in an installed state of the filter element in the filter system.

17. The filter element according to claim 16, further comprising a support pipe, wherein the filter medium is arranged about the support pipe, and wherein the support pipe comprises the seal surface of the seal interface.

18. The filter element according to claim 17, wherein the support pipe comprises a radially inwardly projecting rim and wherein the seal surface of the seal interface is arranged at the radially inwardly projecting rim.

19. A filter element for a filter system, the filter element comprising:
a support pipe;
a filter medium arranged as a single layer or many layers on the support pipe;
a circumferentially extending socket arranged at a first end face of the filter medium and projecting in an axial direction;
a cover arranged at the oppositely positioned second end face of the filter medium;
wherein the cover comprises a seal surface or a seal element, which seal surface or seal element, in an installed state of the filter element in the filter system, is configured to form as intended a seal interface together with another filter element.

20. The filter element according to claim 19, wherein the cover comprises a circumferentially extending projection projecting in the axial direction away from the cover, wherein the circumferentially extending projection carries the seal element.
